(19) United States
(12) Patent Application Publication
(10) Pub. No.: US 2016/0235209 A1
(43) Pub. Date: Aug. 18, 2016

(54) COLLAPSIBLE BED

(71) Applicant: EXTRAORD-N-AIR INC., Van Nuys, CA (US)

(72) Inventors: Nidya Cervantes, Van Nuys, CA (US); Joel Cervantes, Van Nuys, CA (US)

(21) Appl. No.: 14/622,504

(22) Filed: Feb. 13, 2015

(51) Int. Cl. A47C 19/12; A47C 31/00; B60N 3/00

(52) U.S. Cl. CPC A47C 19/12; B60N 3/008; A47C 31/00

(57) ABSTRACT

A collapsible bed for selectively and alternatively being configured in an erected state and a collapsed state, and including a foldable top panel configured to fold along a first axis, and a base assembly configured to be coupled to the foldable top panel, the base assembly including a first side panel, a second side panel, and a front panel, wherein, when the collapsible bed is in the erected state, the first side panel is laterally spaced from the second side panel, wherein the first and second side panels are configured to be pivotally coupled to the foldable top panel along respective second and third axes substantially parallel to the first axis, and wherein the front panel is configured to be pivotally coupled to the first side panel about a fourth axis, the fourth axis being substantially orthogonal to the first axis when the collapsible bed in in the erected state.

### TECHNICAL FIELD

Aspects of embodiments of the present invention relate to a bed, and more particularly, to a portable collapsible bed.

### BACKGROUND

Portable beds are commonly used today to provide temporary sleeping accommodations. Portable beds may be used, for example, when traveling, when setting up temporary work or care stations (such as temporary hospitals), and in a variety of other situations.

For instance, when traveling, berthing seats in vehicles provide one possible sleeping solution for passengers. However, berthing seats are often awkward to use, expose the seatbacks to damage, and when finally made-up into beds, the resulting sleep accommodation is narrow and uncomfortable. If one wishes to sleep lying on one's side, all the underlying seat shapes make finding a comfortable sleeping position very difficult.

Inflatable flat beds have been developed, which may provide more comfortable sleeping arrangements. However, inflatable beds are generally not uniform in feeling and firmness over their entire surface, and are prone to deflation while in use, particularly, in the presence of altitude changes. Further, inflatable beds often require separate air pumps to reach an inflated state.

### SUMMARY

Aspects of embodiments of the present invention are directed toward a collapsible bed configured to be selectively deployed in an erect position in which the collapsible bed provides a stable, sturdy, and comfortable sleep platform, while making efficient use of available space. According to some embodiments, the collapsible bed may also provide a storage compartment when in the erected state.

Aspects of embodiments of the present invention are directed toward a collapsible bed configured to be selectively folded into a collapsed state in which the collapsible bed becomes compact and portable.

According to an aspect of embodiments of the present invention, there is provided a collapsible bed for selectively and alternatively being configured in an erected state and a collapsed state, the collapsible bed including: a foldable top panel configured to fold along a first fold axis; and a base assembly configured to be coupled to the foldable top panel, the base assembly including a first side panel, a second side panel, and a front panel, wherein, when the collapsible bed is in the erected state, the first side panel is laterally spaced from the second side panel, and the front panel is between the first and second side panels, wherein the first and second side panels are configured to be pivotally coupled to the foldable top panel along respective second and third fold axes substantially parallel to the first fold axis, and wherein the front panel is configured to be pivotally coupled to the first side panel about a fourth fold axis, the fourth fold axis being substantially orthogonal to the first fold axis when the collapsible bed in in the erected state.

In an embodiment, the first side panel is substantially parallel to the second side panel when the collapsible bed is in the erected state.

In an embodiment, the front panel is orthogonal to the first and second side panels when the collapsible bed is in the erected state.

In an embodiment, the first fold axis is along a widthwise direction of the foldable top panel.

In an embodiment, the foldable top panel is symmetric about the first fold axis.

In an embodiment, the second fold axis is laterally spaced from the first fold axis.

In an embodiment, the third fold axis is laterally spaced from the first fold axis such that the first fold axis is between the second and third fold axes.

In an embodiment, when the collapsible bed is in the erected state, the front panel is laterally biased from a center of the first and second side panels.

In an embodiment, the collapsible bed further includes a first locking mechanism configured to fix a position of the front panel with respect to the second side panel when the collapsible bed is in the erected state.

In an embodiment, when the collapsible bed is in the erected state, the foldable top panel defines a substantially flat surface, and the first, second, and front panels are substantially orthogonal to the foldable top panel.

In an embodiment, the collapsible bed further includes a second locking mechanism configured to fix a position of the front panel with respect to the foldable top panel when the collapsible bed is in the erected state.

In an embodiment, when the collapsible bed is in the erected state, the foldable top panel and the base assembly together define a storage chamber configured to store objects.

In an embodiment, the front panel includes a frame and a door configured to be pivotally coupled to the frame, and wherein the door is configured to permit access to the chamber when the collapsible bed is in the erected state.

In an embodiment, when the collapsible bed is in the collapsed state, the first and second side panels are further configured to couple to respective distal portions of the foldable top panel at distal ends of the first and second side panels opposite from edges pivotally coupled to the foldable top panel.

In an embodiment, the collapsible bed further includes third and fourth locking mechanisms configured to fix a position of respective ones of the first and second side panels with respect to the foldable top panel when the collapsible bed is in the erected state.

In an embodiment, in the collapsed state, the collapsible bed has a length substantially equal to half of a length of the foldable top panel when the collapsible bed is in the erected state.

In an embodiment, the foldable top panel includes a protrusion along each of distal portions of the foldable top panel, wherein each of the protrusions extends in a direction parallel to the first fold axis and is on a side of foldable top panel opposite from the front panel when the collapsible bed is in the erected state.

In an embodiment, a width of the foldable top panel is greater at a distal portion than at a center of the foldable top panel.

In an embodiment, the foldable top panel includes a first top panel and a second top panel, the first and second top panels are configured to be pivotally coupled together along the first fold axis, each of the first and second top panels including an upper surface and a lower surface.

In an embodiment, when the collapsible bed is in the collapsed state, the upper surface of the first top panel faces the upper surface of the second top panel, the first side panel faces the lower surface of the first top panel and the second side panel faces the lower surface of the second top panel.

In an embodiment, when the collapsible bed is in the collapsed state, the front panel faces the first side panel.

In an embodiment, when the collapsible bed is in the collapsed state, the fourth fold axis is substantially parallel to the first top panel.

According to an aspect of embodiments of the present invention, there is provided a collapsible bed for use in a vehicle and for selectively and alternatively being configured in an erected state and a collapsed state, the collapsible bed including: a foldable top panel configured to fold along a first fold axis; and a base assembly configured to be coupled to the foldable top panel, the base assembly including a first side panel, a second side panel, and a front panel, wherein the first side panel is laterally spaced from the second side panel, and the front panel is between the first and second side panels when the collapsible bed is in the erected state, wherein the first and second side panels are configured to be pivotally coupled to the foldable top panel along respective second and third fold axes substantially parallel to the first fold axis, wherein the front panel is configured to be pivotally coupled to the first side panel about a fourth fold axis, the fourth fold axis being substantially orthogonal to the first fold axis when the collapsible bed in in the erected state, and wherein, when the collapsible bed is in the erected state, the first side panel and the foldable top panel define a first recess, and the second side panel and the foldable top panel define a second recess, the first and second recesses being laterally separated by the base assembly, and each of the first and second recesses being configured to accommodate a seat portion of a chair of the vehicle.

In an embodiment, the foldable top panel includes a protrusion along each of distal portions of the foldable top panel, the protrusion extending in a direction parallel to the first fold axis and on a side of foldable top panel opposite from the front panel.

In an embodiment, the protrusion is configured to rest on a window rail of the vehicle.

In an embodiment, the collapsible bed is configured to be portable and capable of being carried on the vehicle when in the collapsed state.

Additional aspects and/or advantages of embodiments of the present invention are set forth in the following description and accompanying drawings, or may be obvious in view thereof to those skilled in the art.

### BRIEF DESCRIPTION OF THE DRAWINGS

The above and other features and advantages will become more apparent to those of ordinary skill in the art by describing in detail some exemplary embodiments of the present invention with reference to the attached drawings, in which:

FIG. 1 is a schematic illustration of a rear perspective view of the collapsible bed in an erected state, according to some embodiments of the present invention;

FIGS. 2 and 3 are schematic illustrations of a rear view and a front perspective view, respectively, of the collapsible bed 10 in an erected state, and in a partial collapsed state, according to some embodiments of the present invention;

FIGS. 4A and 4B are schematic illustrations of perspective views of opposite sides of the collapsible bed 10 in a collapsed state, according to some embodiments of the present invention;

FIG. 5 is a schematic illustration of a cutaway perspective view of a sandwich structure panel of the collapsible bed 10, according to some example embodiments of the present invention; and

FIG. 6 is a schematic illustration of a perspective view of the collapsible bed 10 when utilized as a sleeping surface in between facing chairs of a vehicle, according to some embodiments of the present invention.

### DETAILED DESCRIPTION

Some exemplary embodiments of the present invention will now be described more fully hereinafter with reference to the accompanying drawings; however, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art.

The present disclosure is directed to various embodiments of a collapsible bed. Embodiments of the collapsible bed of the present disclosure provide a lightweight, compact, and portable sleeping solution that is study, yet provides a comfortable sleeping surface, makes efficient use of available space, and is capable of being quickly erected and collapsed.

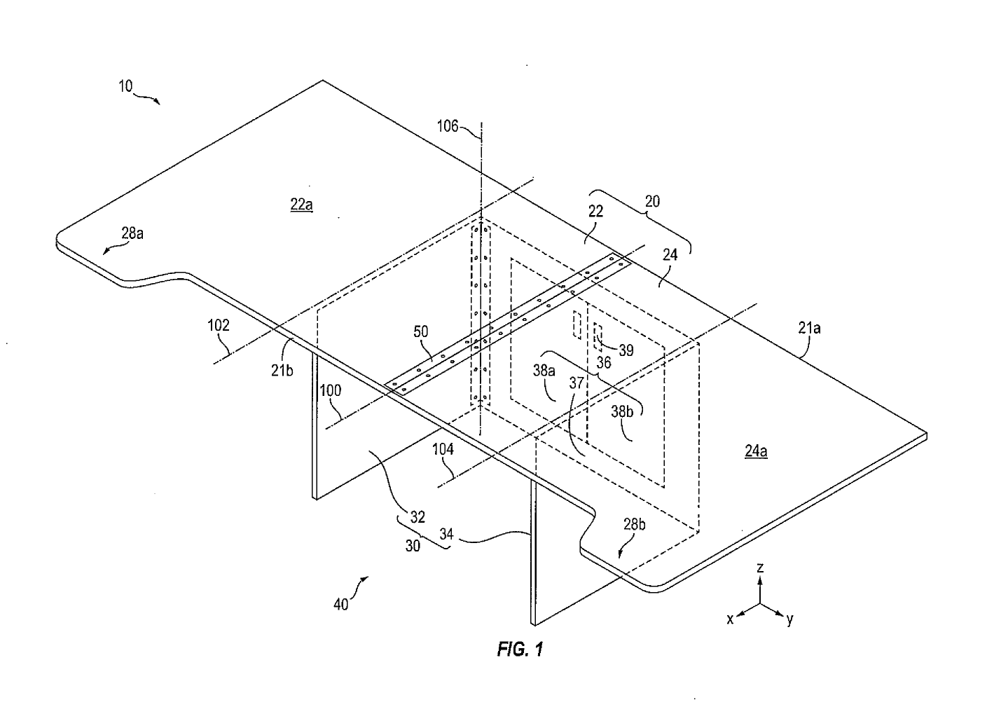

FIG. 1 is a schematic illustration of a rear perspective view of the collapsible bed in an erected state, according to some embodiments of the present invention.

With reference to FIG. 1, a collapsible bed 10 includes a foldable top panel 20 for providing a resting surface and a base assembly 30 for providing structural support to the foldable top panel 20 and for erecting the foldable top panel 20 in an elevated position relative to ground.

According to some embodiments, the foldable top panel 20 is configured to fold (e.g., fold onto itself) along a first fold axis 100. In some embodiments, the foldable top panel 20 includes a first top panel 22 and a second top panel 24, which may be pivotally coupled together (e.g., hingedly coupled together) along the first fold axis 100. The first fold axis 100 may extend along a widthwise direction of the foldable top panel 20 (e.g., the X-direction, as shown in FIG. 1). The first fold axis 100 may be at a midpoint along the length of the foldable top panel 20, and thus, the foldable top panel 20 may be symmetric about the first fold axis 100. However, embodiments of the present invention are not limited thereto, and the first fold axis 100 may be off-center and/or the profile of the foldable top panel 20 may be asymmetric with respect to the first fold axis 100. The first fold axis 100 may reside on an upper surface of the foldable top panel 20 (e.g., opposite from a surface of the foldable top panel 20 adjacent to the base assembly 30).

When the collapsible bed 10 is in an erected state, the foldable top panel 20 may be substantially flat, that is, the first and second top panels 22 and 24 may reside on a same horizontal plane (e.g., the X-Y plane shown in FIG. 1). In such a state, the foldable top panel 20 rests on, and is held in place by, the base assembly 30.

In the illustrated embodiment, the base assembly 30 includes a first side panel 32, a second side panel 34, and a front panel 36. According to some embodiments, the base assembly 30 is configured to be coupled to the foldable top panel 20. In some embodiments, when the collapsible bed 10 is in the erected state, the first side panel 32 is laterally spaced from the second side panel 34, and the front panel 36 is between the first and second side panels 32 and 34. In the erected state, the first side panel 32 may be facing, and be substantially parallel to, the second side panel 34. For example, the first and second side panels 32 and 34 may reside in substantially parallel vertical planes (e.g., planes parallel to the X-Z plane shown in FIG. 1). Each of the first and second side panels 32 and 34 are configured to be pivotally coupled to (e.g., hingedly coupled to) the foldable top panel 20 along respective second and third fold axes 102 and 104, which may be substantially parallel to the first fold axis 100 (e.g., extend in the X direction shown in FIG. 1), and which may reside on a lower surface of the foldable top panel 20. The second and third fold axes 102 and 104 are laterally spaced from the first fold axis 100, such that the first fold axis 100 is between the second and third fold axes 102 and 104. In some examples, the first fold axis 100 may be equidistance from the second and third fold axes 102 and 104.

In some embodiments, the front panel 36 is pivotally coupled to (e.g., hingedly coupled to) the first side panel 32 about a fourth fold axis 106, which may be substantially orthogonal to the first fold axis 100 when the collapsible bed 10 is in the erected state. For example, the fourth fold axis 106 may extend along a lengthwise direction of the first side panel 32 and the front panel 36 (e.g., the Z-direction, as shown in FIG. 1). However, embodiments of the present invention are not limited thereto, and the front panel 36 may be pivotally coupled to (e.g., hingedly coupled to) the second side panel 34 about another fold axis parallel to the fourth fold axis 106. In some examples, the front panel 36 may reside in a vertical plane (e.g., a plane parallel to the Y-Z plane shown in FIG. 1) orthogonal to the first and second side panels 32 and 34.

According to some embodiments, when the collapsible bed 10 is in an erect state, the front panel 36 may be biased away from (e.g., offset from) the center of the foldable top panel 20 and be positioned proximate to a first lengthwise edge 21a of the foldable top panel 20. In the erected state, the first and second side panels 32 and 34 together with the front panel 36 and the bottom of the foldable top panel 20 may define a chamber (e.g., a cuboidal storage chamber, a compartment, or a cavity) 40, which may utilized as a storage space within the collapsible bed 10 to accommodate various objects. The off-center bias of the front panel 36 may be selected based on the desired storage space within the chamber 40 (e.g., to maximize the storage space within the chamber 40), while affording the collapsible bed 10 adequate tilt stability (about a lengthwise axis of the foldable top panel 20). The storage volume of the chamber 40 may be approximately determined by the product of a width of the first and second side panels 32 and 34 and the front panel 36 (e.g., along the X direction shown in FIG. 1), a width of the front panel 36 (e.g., along the Y direction shown in FIG. 1), and the height of the first and second side panels 32 and 34 (e.g., along the Z direction shown in FIG. 1).

In some embodiments, the front panel 36 includes a frame 37 and an access door configured to be coupled to (e.g., hingedly coupled to) the frame 37, and to permit access to the chamber 40 when the collapsible bed 10 is in the erected state. The door may include a sliding door, a swing door, an accordion door, or any other suitable means of permitting access to the chamber 40 as recognized by a person of ordinary skill in the art. In some examples, the access door includes first and second swing doors 38a and 38b, which may be hinged to the frame 37 along one or more of the frame's 37 interior edges (e.g., the vertical interior edges of the frame 37 along the Z direction shown in FIG. 1), and one or more door handles 39 to allow a user to open and close the access door.

According to some embodiments, the foldable top panel 20 includes protrusions 28a and 28b along respective distal portions of the foldable top panel. The protrusions 28a and 28b may reside along a second lengthwise edge 21b of the foldable top panel 20 opposite from the front panel 36 (e.g., opposite the first lengthwise edge 21a) and extend in a direction parallel to the first fold axis 100 when the collapsible bed is in the erected state. Additionally, an intermediate portion of the foldable top panel 20 between the distal portions of the foldable top panel 20 includes a recessed portion defined between the protrusions 28a, 28b.

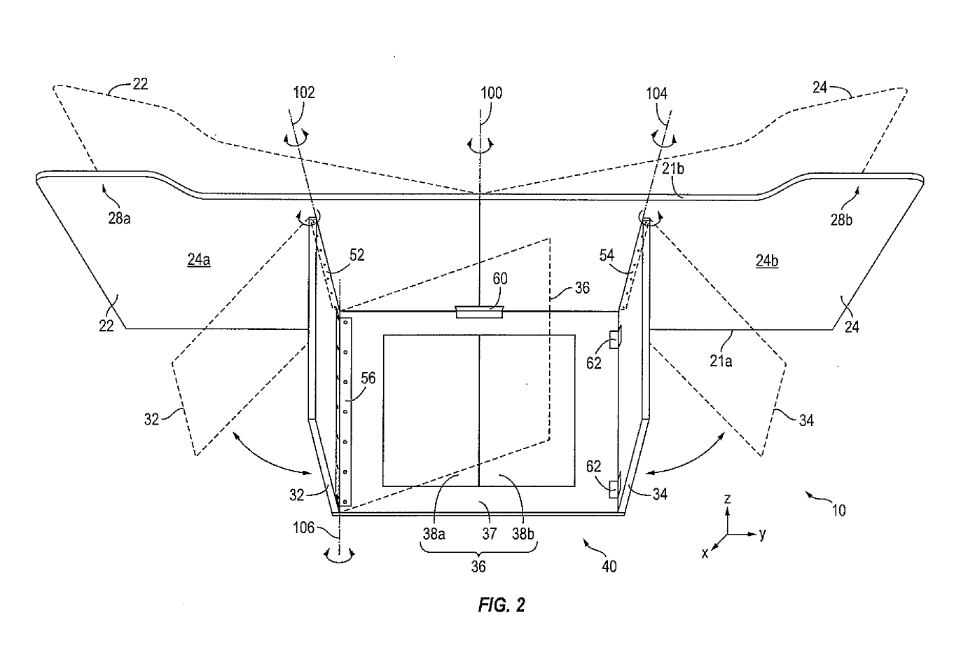

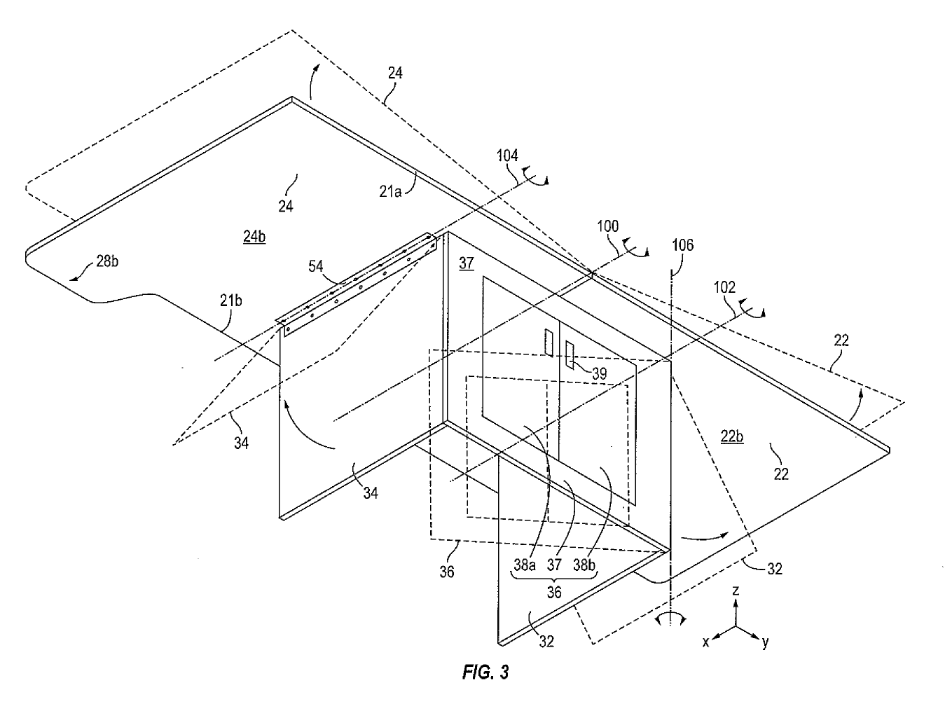

FIGS. 2 and 3 are schematic illustrations of a rear view and a front perspective view, respectively, of the collapsible bed 10 in an erected state, and in a partial collapsed state, according to some embodiments of the present invention.

In some embodiments, the first and second top panels 22 and 24 are coupled together via a top hinge 50, and the first and second side panels 32 and 34 are respectively coupled to the first and second top panels 22 and 24 via respective ones of the first and second hinges 52 and 54. Similarly, the front panel 36 may be coupled to the first side panel 32 via the third hinge 56. Each of the first, second, and third hinges 52, 54, and 56 may include any suitable hinge, such as a butt-hinge, a t-hinge, a strap hinge, a gate-hinge, a double acting hinge, a soss hinge, a cabinet hinge, a self-closing hinge, and/or the like.

The top hinge 50 permits the first and second top panels 22 and 24 to fold from an erect position, in which the foldable top panel 20 is substantially flat (as shown in solid lines in FIGS. 2 and 3), to a folded position in which the distal ends of the first and second top panel 22 and 24 (i.e., the respective ends of the first and second top panel 22 and 24 opposite from the top hinge 50) move closer to one another (as shown in phantom lines in FIGS. 2 and 3). Thus, the top hinge 50 allows substantially 180 degree or more of freedom for folding of the foldable top panel 20 (i.e. the pivoting of the first and second top panels 22 and 24 toward one another).

First and second hinges 52 and 54 permit the first and second side panels 32 and 34 to fold out (e.g., flare out) from a vertical erect position (as shown in solid lines in FIGS. 2 and 3) to a flared position (as shown in phantom lines in FIGS. 2 and 3) toward opposite distal ends of the foldable top panel 20. In the illustrated embodiment, lower ends of the first and second side panels 32 and 34 are configured to fold out away from the top hinge 50 and the first fold axis 100. Thus, the first and second hinges 52 and 54 allow substantially 90 degree or more of freedom for pivoting of the first and second side panels 32 and 34 with respect to the foldable top panel 20.

The third hinge 56 permits the front panel 36 to fold inward from an erect position, in which the front panel 36 is substantially orthogonal to the first side panel 32 (as shown in solid lines in FIGS. 2 and 3), to a folded position (as shown in phantom lines in FIGS. 2 and 3) toward a rear edge of the first side panel 32 opposite from the third hinge 56. Thus, the third hinge 56 allows substantially 90 degree or more of freedom for pivoting of the front panel 36 with respect to the first side panel 32.

According to some embodiments, when the collapsible bed 10 is in an erected state, the base assembly 30 (e.g., the first and second side panels 32, 34 and the front panel 36) maintains a U-shape (or C-shape) structure by fixedly coupling together (e.g., securing or locking together) the front panel 36 and the second side panel 34 via a locking mechanism 62. However, in embodiments in which the front panel 36 is pivotally coupled to the second side panel 34, instead of the first side panel 32, the front panel 36 may be fixedly coupled to the first side Panel 32 rather than the second side panel 34 via the locking mechanism 62. As the front panel 36 is pivotally coupled to one of the first and second side panels 32 and 34, locking the front panel 36 to the other of the first and second side panels 32 and 34 turns the base assembly 30 into a unified and integrated (e.g., a wholly connected or cohesive) assembly, which prevents or substantially prevents the first and second side panels 32 and 34 from flapping about and/or folding upward toward the distal ends of the foldable top panel 20, and maintains the first and second side panels 32 and 34 in a substantially vertical position (e.g., a position whereby the first and second side panels 32 and 34 reside in parallel X-Z planes as shown in FIG. 2).

In the erected state, the base assembly 30 is secured to the foldable top panel 20 via the locking mechanism 60, in addition to the hinges 52 and 54. In some embodiments, the locking mechanism 60 may lock the front panel 36 to one or both of the first and second top panels 22 and 24, thus fixing the position of the front panel 36 relative to the foldable top panel 20. In examples in which the front panel 36 is pivotally coupled to the first side panel 32 (as illustrated in FIGS. 2 and 3), the locking mechanism 60 may be configured to lock the front panel 36 to at least the second top panel 24, and in examples in which the front panel 36 is pivotally coupled to the second side panel 34, the locking mechanism 60 may be configured to lock the front panel 36 to at least the first top panel 22. In addition to securing the base assembly 30 to the foldable top panel 20, such a configuration may ensure that the foldable top panel 20 does not fold (upward or downward) along the first fold axis 100, and maintains a substantially flat posture, when the collapsible bed 10 is in the erected state.

Each of the locking mechanisms 60 and 62 may include one or more latches, such as slide bolt latches, or any other suitable locking mechanisms, as recognized by one of ordinary skill in the art.

While the illustrations of FIGS. 1-3 depict the foldable top panel 20, the first and second side panels 32 and 34, and the front panel 36 as two dimensional sheets, such representation is for ease of illustration purposes only, and as recognized by a person of ordinary skill in the art, each of the aforementioned panels is a 3-dimensional element having a thickness suitable for a desired application.

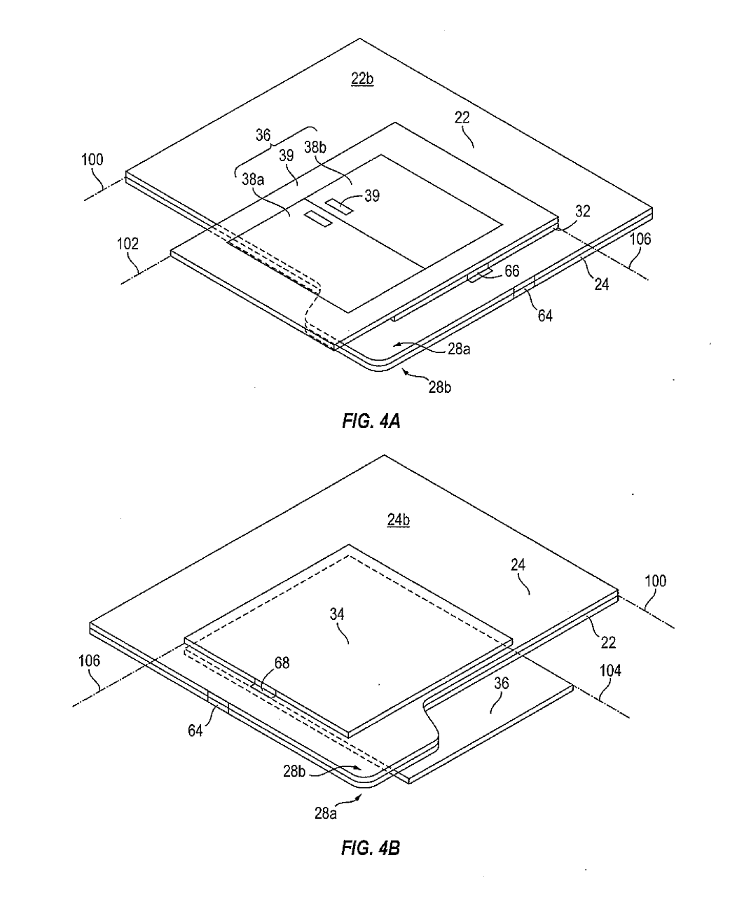

FIGS. 4A and 4B are schematic illustrations of perspective views of opposite sides of the collapsible bed 10 in a collapsed state, according to some embodiments of the present invention.

According to some embodiments, in the collapsed state, the foldable top panel 20 is completely folded about the first fold axis 100 such that an upper surface 22a of the first top panel 22 faces, and is substantially parallel to an upper surface 24a of the second top panel 24. Thus, the first and second top panels 22 and 24 may abut against one another. In some examples, a gap may exist between at least a portion of the upper surfaces 22a and 24a of the first and second top panels 22 and 24 when the collapsible bed 10 is in a collapsed state,

In the collapsed state, the first and second side panels 32 and 34 may be folded along respective second and third fold axes 102 and 104 toward distal ends of the foldable top panel 20 (e.g., ends of the first and second top panels 22 and 24 opposite from the top hinge 50 and/or corresponding to the protrusions 28a and 28b). The first and second side panels 32 and 34 may be folded such that they face, and are substantially parallel to, the lower surfaces 22b and 24b of respective ones of the first and second top panels 22 and 24. In some examples, a gap may exist between at least a portion of the lower surfaces 22b and 24b of the first and second top panels 22 and 24 and the respective ones of the first and second side panels 32 and 34 when the collapsible bed 10 is in a collapsed state.

In embodiments in which the front panel 36 is pivotally coupled to the first side panel 32 (as illustrated in FIGS. 4A and 4B), when in the collapsed state, the front panel 36 may fold onto the first side panel 32 such that the front panel 36 faces, and is substantially parallel to, a surface of the first side panel 32 opposite from the surface of the first side panel 32 facing the lower surface 22b of the first top panel 22. Similarly, in embodiments in which the front panel 36 is pivotally coupled to the second side panel 34, the front panel 36 may fold onto the second side panel 34 such that the front panel 36 faces, and is substantially parallel to, a surface of the second side panel 34 opposite from the surface of the second side panel 34 facing the lower surface 24b of the second top panel 24. While in the collapsed state, the front panel 36 may abut against said surface of the second side panel 34, or a gap may exist between the front panel 36 and some or all of said surface.

In the collapsed state, the front panel 36 may substantially overlap with the first and second side panels 32 and 34. Depending on the relative dimensions (e.g., relative widths) of the first and second side panel 32 and 34 and the front panel 36, the front panel 36 may extend beyond edges of the first and second side panel 32 and 34 opposite to the fourth fold axis 106. In some examples, the front panel 36 may extend beyond the protrusions 28a and 28b of the first and second top panels 22 and 24.

Accordingly, when the collapsible bed 10 is in the collapsed state, its constituent panels may be stacked on top of one another in this order: front panel 36, one of the first and second side panels 32 and 34, the first and second top panels 22 and 24, and then the other of the first and second side panels 32 and 34. In such a configuration, the fourth fold axis 106 may be substantially orthogonal to the first, second, and third fold axes 100, 102, and 104, which are parallel to one another.

In some embodiments, the collapsible bed 10 includes locking mechanism 64 for securing (e.g., locking or fixing the relative positions of) the distal ends of the foldable top panel 20 together once the collapsible bed 10 is collapsed. The collapsible bed 10 may further include locking mechanisms 66 and 68. In embodiments in which the front panel 36 is pivotally coupled to the first side panel 32 (as illustrated in FIGS. 4A and 4B), the locking mechanism 66 is configured to secure one or more of the front panel 36 and the first side panel 32 to the first top panel 22, and the locking mechanism 68 is configured to secure the second side panel 34 to the second top panel 24. In embodiments in which the front panel 36 is pivotally coupled to the second side panel 34, the locking mechanism 66 is configured to secure one or more of the front panel 36 and the second side panel 34 to the second top panel 24, and the locking mechanism 68 is configured to secure the first side panel 32 to the first top panel 22.

Similar to the locking mechanism 60 and 62, each of the locking mechanisms 64, 66, and 68 may include one or more latches, such as slide bolt latches, or any other suitable locking mechanisms, as recognized by one of ordinary skill in the art.

When in the collapsed state, the length of the collapsible bed 10 may be about half that of the collapsible bed in the erected state, while the width of the width of the collapsible bed 10 may be substantially similar in the two states. Thus, in some embodiments, when in the collapsed state, the collapsible bed 10 is compact and portable, capable of being carried (e.g., in a carrying pouch) by a user.

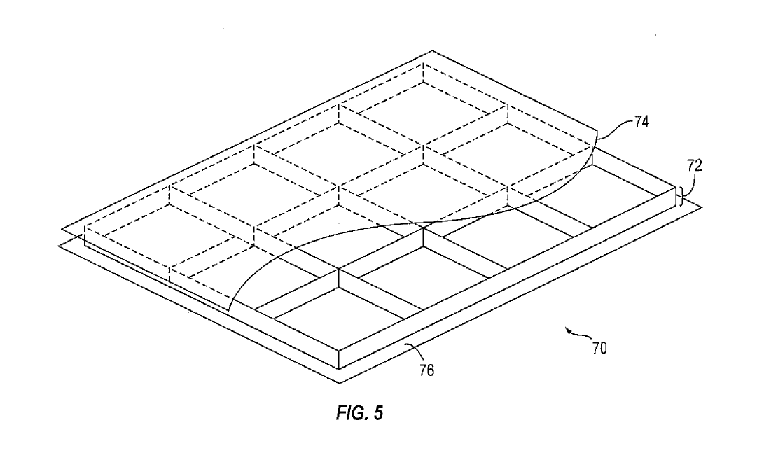

FIG. 5 is a schematic illustration of a cutaway perspective view of a sandwich structure panel of the collapsible bed 10, according to some example embodiments of the present invention.

In some embodiments, one or more of the first and second top panels 22 and 24, the first and second side panels 32 and 34, and the front panel 36 include a sandwich structure panel 70, which has a core 72 pressed between first and second face sheets 74 and 76. The sandwich structure panel 70 may be a metal composite material (MCM) having two thin face sheets 74 and 76 bonded to a lightweight plastic core 72. The core 72 may include open-and-closed-cell-structured foam, such as a metal foam, polyvinylchloride, polyurethane, polyethylene or polystyrene foams, balsa wood, syntactic foams, honeycombs, and/or the like. The first and second face sheets 74 and 76 may include glass, carbon fiber-reinforced thermoplastics, thermoset polymers, sheet metal, and/or the like. The use of sandwich structured panels 70 affords the collapsible bed 10 with high bending stiffness and low weight. Thus, in some example embodiments, the collapsible bed 10 may weigh from about 3 kg to about 10 kg.

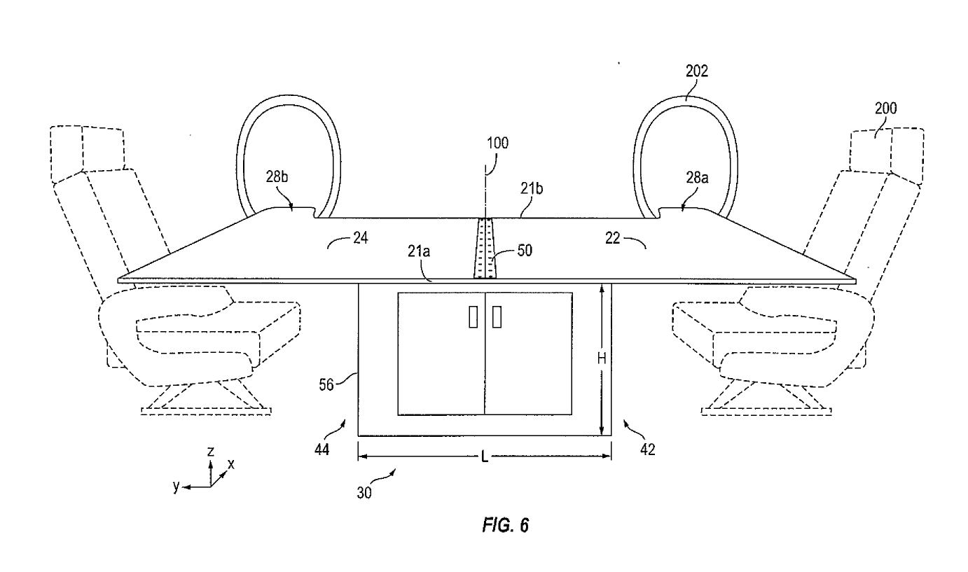

FIG. 6 is a schematic illustration of a perspective view of the collapsible bed 10 when utilized as a sleeping surface in between facing chairs of a vehicle, according to some embodiments of the present invention.

According to some embodiments, the first and second side panels 32 and 34 and the respective first and second top panels 22 and 24 respectively form recesses 42 and 44 external to the base assembly 30. The recesses 42 and 44 may be configured to accommodate, for example, facing chairs 200 in a vehicle (e.g., a commercial jet or a luxury bus). For example, the height H of the base assembly 30 (e.g., the length of the front panel 36 along the Z direction shown in FIG. 6) may be set such that there is sufficient clearance to permit the arm rests of chairs 200 to fit under the first and second top panels 22 and 24. In some examples, the height H may be set to allow the first and second top panels 22 and 24 to abut against and rest on top of the arm rests of a pair of facing chairs 200, which may maximize the stability of the collapsible bed 10 in the erected state.

The length L of the base assembly 30 (e.g., the length of the front panel 36 along the Y direction shown in FIG. 6) may be set to be substantially the same as the separation between two facing chairs 200. In this manner, pitch stability of the collapsible bed 10 about the first fold axis 100, as well as the storage capacity of the chamber 40 may be increased (e.g., maximized).

In embodiments in which the collapsible bed 10 is utilized in a vehicle, such as a commercial jet or a luxury bus, and/or the like, the first lengthwise edge 21a of the foldable top panel 20, which is on a side of the collapsible bed 10 corresponding to the front panel 36, may be substantially straight and adjacent to the aisle of the vehicle. However, the second lengthwise edge 21b of the foldable top panel 20 may be scalloped shaped with two protrusions 28a and 28b at the distal ends of the foldable top panel 20. The profile of the protrusions 28a and 28b may be set such that the protrusions 28a and 28b cover and rest on rails (e.g., drink rails) provided near the windows 202 of the vehicle. Thus, the width of the foldable top panel 20 is greater at the distal ends corresponding to the protrusions 28a and 28b than at the center corresponding to the first fold axis 100. The protrusions 28a and 28b may provide further roll or tilt stability (about a lengthwise axis of the foldable top panel 20) to the collapsible bed 10 than otherwise provided by the base assembly 30. The protrusions 28a and 28b further increase the top surface area of the foldable top panel 20 thus providing more rest space on the collapsible bed 10.

In some examples, some or all of the collapsible bed 10 may be painted and/or covered by upholstery (e.g., leather upholstery) as may be desired in a particular application. Further, when in the erected state, the collapsible bed 10 may be covered by one or more layers of deformable material, such as dense foam, memory foam, and/or the like, with suitable thickness, to provide a comfortable resting surface to a user.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the collapsible bed in use or in operation, in addition to the orientation depicted in the figures. For example, if the collapsible bed in the figures is turned over, elements described as “below” or “beneath” or “under” other elements or features would then be oriented “above” the other elements or features. Thus, the example terms “below” and “under” can encompass both an orientation of above and below. The collapsible bed may be otherwise oriented (e.g., rotated 90 degrees or at other orientations) and the spatially relative descriptors used herein should be interpreted accordingly. In addition, it will also be understood that when a component is referred to as being “between” two components, it can be the only component between the two components, or one or more intervening components may also be present.

The terminology used herein is for the purpose of describing particular embodiments only and is not intended to be limiting of the inventive concept. As used herein, the singular forms “a” and “an” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Expressions such as “at least one of,” when preceding a list of elements, modify the entire list of elements and do not modify the individual elements of the list. Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent to” another element or layer, it can be directly on, connected to, coupled to, or adjacent to the other element or layer, or one or more intervening elements or layers may be present. When an element or layer is referred to as being “directly on,” “directly connected to”, “directly coupled to”, or “immediately adjacent to” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

The preceding description has been presented with reference to some exemplary embodiments of the invention. Persons skilled in the art and technology to which this invention pertains will appreciate that alterations and changes in the described structures and methods of assembly and operation can be practiced without meaningfully departing from the principles, spirit, and scope of this invention, as set forth in the following claims, and equivalents thereof.

What is claimed is:

1. A collapsible bed for selectively and alternatively being configured in an erected state and a collapsed state, the collapsible bed comprising:
a foldable top panel configured to fold along a first fold axis; and
a base assembly configured to be coupled to the foldable top panel, the base assembly comprising a first side panel, a second side panel, and a front panel, wherein, when the collapsible bed is in the erected state, the first side panel is laterally spaced from the second side panel, and the front panel is between the first and second side panels,
wherein the first and second side panels are configured to be pivotally coupled to the foldable top panel along respective second and third fold axes substantially parallel to the first fold axis, and
wherein the front panel is configured to be pivotally coupled to the first side panel about a fourth fold axis, the fourth fold axis being substantially orthogonal to the first fold axis when the collapsible bed in in the erected state.

2. The collapsible bed of claim 1, wherein the first side panel is substantially parallel to the second side panel when the collapsible bed is in the erected state.

3. The collapsible bed of claim 1, wherein the front panel is orthogonal to the first and second side panels when the collapsible bed is in the erected state.

4. The collapsible bed of claim 1, wherein the first fold axis is along a widthwise direction of the foldable top panel.

5. The collapsible bed of claim 1, wherein the foldable top panel is symmetric about the first fold axis.

6. The collapsible bed of claim 1, wherein the second fold axis is laterally spaced from the first fold axis.

7. The collapsible bed of claim 6, wherein the third fold axis is laterally spaced from the first fold axis such that the first fold axis is between the second and third fold axes.

8. The collapsible bed of claim 1, wherein, when the collapsible bed is in the erected state, the front panel is laterally biased from a center of the first and second side panels.

9. The collapsible bed of claim 1, wherein the collapsible bed further comprises a first locking mechanism configured to fix a position of the front panel with respect to the second side panel when the collapsible bed is in the erected state.

10. The collapsible bed of claim 1, wherein when the collapsible bed is in the erected state, the foldable top panel defines a substantially flat surface, and the first, second, and front panels are substantially orthogonal to the foldable top panel.

11. The collapsible bed of claim 1, wherein the collapsible bed further comprises a second locking mechanism configured to fix a position of the front panel with respect to the foldable top panel when the collapsible bed is in the erected state.

12. The collapsible bed of claim 1, wherein, when the collapsible bed is in the erected state, the foldable top panel and the base assembly together define a storage chamber configured to store objects.

13. The collapsible bed of claim 12, wherein the front panel comprises a frame and a door configured to be pivotally coupled to the frame, and wherein the door is configured to permit access to the chamber when the collapsible bed is in the erected state.

14. The collapsible bed of claim 1, wherein, when the collapsible bed is in the collapsed state, the first and second side panels are further configured to couple to respective distal portions of the foldable top panel at distal ends of the first and second side panels opposite from edges pivotally coupled to the foldable top panel.

15. The collapsible bed of claim 1, wherein the collapsible bed further comprises third and fourth locking mechanisms configured to fix a position of respective ones of the first and second side panels with respect to the foldable top panel when the collapsible bed is in the erected state.

16. The collapsible bed of claim 1, wherein, in the collapsed state, the collapsible bed has a length substantially equal to half of a length of the foldable top panel when the collapsible bed is in the erected state.

17. The collapsible bed of claim 1, wherein the foldable top panel comprises a protrusion along each of distal portions of the foldable top panel, wherein each of the protrusions extends in a direction parallel to the first fold axis and is on a side of foldable top panel opposite from the front panel when the collapsible bed is in the erected state.

18. The collapsible bed of claim 1, wherein a width of the foldable top panel is greater at a distal portion than at a center of the foldable top panel.

19. The collapsible bed of claim 1, wherein the foldable top panel comprises a first top panel and a second top panel, the first and second top panels are configured to be pivotally coupled together along the first fold axis, each of the first and second top panels comprising an upper surface and a lower surface.

20. The collapsible bed of claim 19, wherein, when the collapsible bed is in the collapsed state, the upper surface of the first top panel faces the upper surface of the second top panel, the first side panel faces the lower surface of the first top panel and the second side panel faces the lower surface of the second top panel.

21. The collapsible bed of claim 19, wherein, when the collapsible bed is in the collapsed state, the front panel faces the first side panel.

22. The collapsible bed of claim 19, wherein, when the collapsible bed is in the collapsed state, the fourth fold axis is substantially parallel to the first top panel.

23. A collapsible bed for use in a vehicle and for selectively and alternatively being configured in an erected state and a collapsed state, the collapsible bed comprising:
a foldable top panel configured to fold along a first fold axis; and
a base assembly configured to be coupled to the foldable top panel, the base assembly comprising a first side panel, a second side panel, and a front panel, wherein the first side panel is laterally spaced from the second side panel, and the front panel is between the first and second side panels when the collapsible bed is in the erected state,
wherein the first and second side panels are configured to be pivotally coupled to the foldable top panel along respective second and third fold axes substantially parallel to the first fold axis,
wherein the front panel is configured to be pivotally coupled to the first side panel about a fourth fold axis, the fourth fold axis being substantially orthogonal to the first fold axis when the collapsible bed in in the erected state, and
wherein, when the collapsible bed is in the erected state, the first side panel and the foldable top panel define a first recess, and the second side panel and the foldable top panel define a second recess, the first and second recesses being laterally separated by the base assembly, and each of the first and second recesses being configured to accommodate a seat portion of a chair of the vehicle.

24. The collapsible bed of claim 23, wherein the foldable top panel comprises a protrusion along each of distal portions of the foldable top panel, the protrusion extending in a direction parallel to the first fold axis and on a side of foldable top panel opposite from the front panel.

25. The collapsible bed of claim 24, wherein the protrusion is configured to rest on a window rail of the vehicle.

26. The collapsible bed of claim 23, wherein the collapsible bed is configured to be portable and capable of being carried on the vehicle when in the collapsed state.
